(19) United States
(12) Patent Application Publication
(10) Pub. No.: US 2009/0150766 A1
(43) Pub. Date: Jun. 11, 2009

(54) SYSTEMS, METHODS AND COMPUTER PROGRAM PRODUCTS FOR APPLYING STYLES FROM ELEMENTS INCLUDED IN AN EXISTING PAGE

(75) Inventors: Susumu Fukuda, Yokohama-shi (JP); Mari Onishi, Sagamihara (JP)

Correspondence Address: Cantor Colburn LLP IBM SVL, 20 Church Street, 22nd Floor, Hartford, CT, 06103-3207, US

(73) Assignee: INTERNATIONAL BUSINESS MACHINES CORPORATION, Armonk, NY (US)

(21) Appl. No.: 11/951,665

(22) Filed: Dec. 6, 2007

(51) Int. Cl. G06F 3/14

(52) U.S. Cl. 715/235

(57) ABSTRACT

Systems, methods, and computer program products for applying styles from elements included in an existing web page. Exemplary embodiments include a method for applying styles from elements included in an existing HTML document, the method including applying an appearance of the existing HTML document specified by using CSS to HTML components in an HTML document being edited for each component, examining a CSS attribute that defines an appearance in each part in a component including attributes inherited from parents and applying a defined CSS class to each part of the destination of the application.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to web page generation, and particularly to systems, methods, and computer program products for applying styles from elements included in an existing web page.

2. Description of Background

Currently, when a page is to be created by the HTML, one of the main markup languages of the Web, an approach for separately defining the contents and appearance (design) of the document for “separating the contents and design” as well as “improving accessibility” is taken. For example, the HTML not only uses the attributes of the HTML tag but also the CSS (Cascading Style Sheet) for specifying appearance. In the XML, there is an approach for defining the appearance by using the XSLT and the CSS. The appearance is a part that is recognized by an end user who is viewing the document by using a Web browser. How the contents appear on a display is important for a page creator. It is essential for the page creator to realize the appearance the maker intends.

In a document whose appearance complies with hierarchically applied rules as in the case where the CSS and the HTML are combined and used, it is difficult to reproduce the appearance of a particular part in the existing document in another region (whether it is inside or outside the document). If such reproduction is attempted, it may affect the appearance of regions other than the objective region.

The conventional Web Authoring Tool takes an approach as below to set the same appearance. For example, current techniques import a CSS file while a component is being inserted for the purpose of defining the appearance of a particular component. When a JSF component is added to a page by using the Page Designer of RAD6, an external CSS file for defining the appearance of the JSF component is imported at the same time. An attribute is added to the component to be inserted for referring to the class defined in the external CSS file. Consistency of the appearance can be ensured for the JSF components so that the appearance same as that of a JSF component used in another part can be realized.

In another example, current techniques examine a style valid at the copy source one by one and apply the style to the copy destination. A series of steps are executed for all the nodes in the range to be copied, and set the obtained style to the copy destination. Finally, a property valid in a node in concern is obtained by using a function for enabling a list of valid classes at the node in concern and their properties to be displayed (provided by the Adobe Dreamweaver) or by performing text search, and apply the properties to the copy destination.

In another example, current techniques copy the HTML and the attribute of the particular region and rewrite the contents part (in case of a table, the contents in the table cell). If a table in an existing page is to be reproduced in another document, a method for copying and pasting the HTML tag (TABLE element) forming the table is usually taken. As a result, the attribute and the inline style defined in the tag are copied. If the class attribute is specified, the definition of the class itself needs to be copied from the existing page or an external CSS at the same time. If the HTML element type (in this case, TABLE, TD and the like) is used as a selector and a style is defined, they also need to be copied, which may alter the appearance of the other tables in the same page. As the attribute and the style defined in a parent tag in the existing page (for example, if TABLE inherits the background-color defined in BODY) are not copied, the appearance is not ensured to be the same as that of the copy source. If the appearance of the page at the copy source is defined in the external CSS, a method for specifying the CSS file as the page of the copy destination may be taken. That case also has a problem in that the appearance of all the same elements in the page is altered or the like if a necessary style is overwritten or the HTML element type is used as the selector according to the other external CSS file and the order with a style to be incorporated.

### SUMMARY OF THE INVENTION

Exemplary embodiments include a method for applying styles from elements included in an existing HTML document, the method including applying an appearance of the existing HTML document specified by using CSS to HTML components in an HTML document being edited for each component, including setting an application source by selecting a range in the existing HTML document, setting an application destination in the HTML document being edited, examining a CSS attribute that defines an appearance in each part in a component including attributes inherited from parents, forming a new CSS for a document of a copy destination, including examining valid properties inherited from a parent page at the copy destination, setting a property that is to be overridden, setting a style that is valid in a child element, copying a style that is valid in a tag included in a copy source and applying a defined CSS class to each part of the destination of the application including applying styles to objects to reproduce a copy source.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which provides systems and methods that enable existing information on the appearance to be applied to the other region without requiring profound knowledge on the CSS and any trouble in implementing multiple steps by providing means for obtaining information on the appearance such as a style from an existing object and applying the information to the destination region of the application.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system 100 for applying styles from elements included in an existing web page;

FIG. 2 illustrates a flowchart of a method for applying styles from elements included in an existing HTML document;

FIG. 3 illustrates a flow diagram illustrating the method of FIG. 2;

FIG. 4 illustrates another flow diagram illustrating the method of FIG. 2;

FIG. 5 illustrates a flow diagram for applying a style to an object in accordance with exemplary embodiments;

FIG. 6 illustrates a flow diagram for text element mapping in accordance with exemplary embodiments; and

FIG. 7 illustrates a flow diagram of table mapping in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, the systems and methods described herein enable existing information on the appearance to be applied to the other region without requiring profound knowledge on the CSS and any trouble in implementing multiple steps by providing means for obtaining information on the appearance such as a style from an existing object and applying the information to the destination region of the application. As such, appearance can be copied in a small number of steps, and load in editing by using the HTML editor or the like can be reduced. In addition, processing can be applied also to the HTML tree generated on a browser. In exemplary embodiments, the types of elements that are included at the copy destination but not included at the copy source (i.e., assuming that elements of appearance are at the copy source, the appearance of the copy destination can be changed). Furthermore, appearance can be copied in minimum setting by examining the attribute of appearance inherited from parent element.

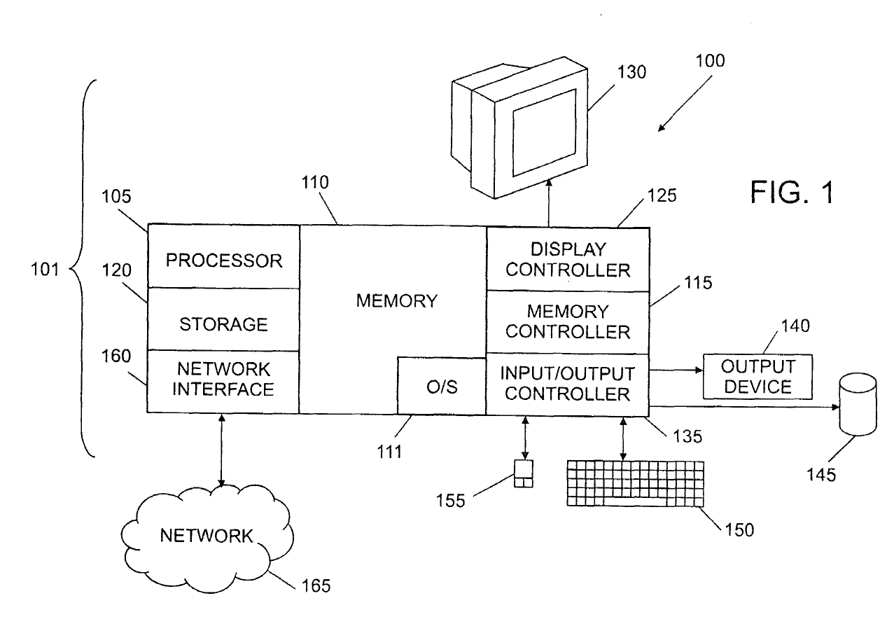

FIG. 1 illustrates an exemplary embodiment of a system 100 for applying styles from elements included in an existing web page. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 101, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the page appearance application methods described herein in accordance with exemplary embodiments and a suitable operating system (OS) 111. The operating system 111 essentially controls the execution of other computer programs, such the page appearance application systems and methods described herein, and provides scheduling, input-output control, file and data management, memory management, and communication control and related services.

The existing page appearance application methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the O/S 111. Furthermore, the existing page appearance application methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The existing page appearance application methods described herein and the OS 111, in whole or in part, but typically the latter, are read by the processor 105, perhaps buffered within the processor 105, and then executed.

When the systems and methods described herein are implemented in software, as is shown in FIG. 1, the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The existing page appearance application methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the existing page appearance application methods are implemented in hardware, the existing page appearance application methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments, one or more processes in the memory 110 can monitor activity from the keyboard 150 and the mouse 155 or a combination thereof. The processes can further monitor long-running jobs that have been initiated on the computer 101. The processes can further monitor which and how many other machines can control the computer 101 either locally or remotely. In exemplary embodiments, the processes can also inquire or accept a grace period input by a user of the computer 101. The grace period can be a time period after which all traffic to and from the computer ceases if no further activity has been sensed by the processes. In this way, if a user has left the computer 101 for an extended period of time or has left the computer (e.g., after a work day) the computer 101 no longer allows traffic to and from the computer 101. In an alternative implementation, the computer 101 can totally power down after the grace period has expired. In further exemplary embodiments, the processes can accept traffic only from a common network maintenance control system that provides limited services.

In exemplary embodiments, the systems and methods described herein apply the appearance of an existing HTML [components] specified by using the CSS to HTML components in a page being edited for each component. The systems and methods examine the CSS attribute that defines the appearance in each part in a component including the attributes inherited from parents and forms a new CSS for a document of the copy destination. Then, the systems and methods apply the defined CSS class to each part of the destination of the application.

As a result, as the CSS class can be applied to each component, no complicated operations are involved. In addition, as an attribute inherited from parents at the copy source is incorporated in a new CSS, the appearance same as that of the copy source can be reproduced. In exemplary embodiments, the methods described herein do not affect the other parts of the same HTML document. By using a method for specifying the appearance that is excellent in the above mentioned points, the systems and methods described herein can appropriately realize copy and paste of the appearance.

In exemplary embodiments, an application source is set by using means for selecting a range in an existing HTML document. Next, an application destination in an HTML document being edited is set by using means for a range in the edited document. Finally, applying processing is performed. In exemplary embodiments, “selected range” is a range that can be selected by means for selecting a range. The range includes “DOM element”, “DOM element string”, and “character string in a text node”. The “DOM element” may include a child element. In exemplary embodiments, the child elements are the types of elements shown below are removed from all the child elements in the “DOM element”, which can include: a text with all space; a meaningless text (a text that does not affect display such as a text between TDs.); a comment; and a script.

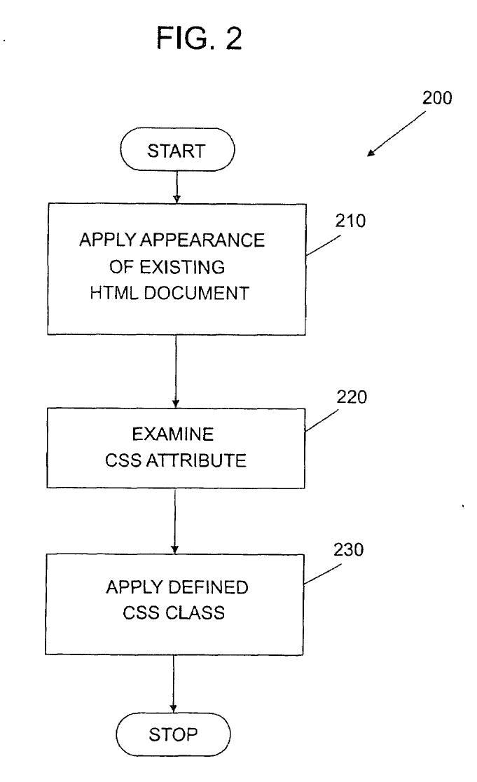

FIG. 2 illustrates a flowchart of a method 200 for applying styles from elements included in an existing HTML document. At block 210, the method 200 applies an appearance of the existing HTML document specified by using CSS to HTML components in an HTML document being edited for each component. Block 210 can include setting an application source by selecting a range in the existing HTML document and setting an application destination in the HTML document being edited. At block 220, the method examines a CSS attribute that defines an appearance in each part in a component including attributes inherited from parents. Block 220 can include forming a new CSS for a document of a copy destination, examining valid properties inherited from a parent page at the copy destination, setting a property that is to be overridden, setting a style that is valid in a child element and copying a style that is valid in a tag included in a copy source. At block 230, the method 200 applies a defined CSS class to each part of the destination of the application that can include applying styles to objects to reproduce a copy source.

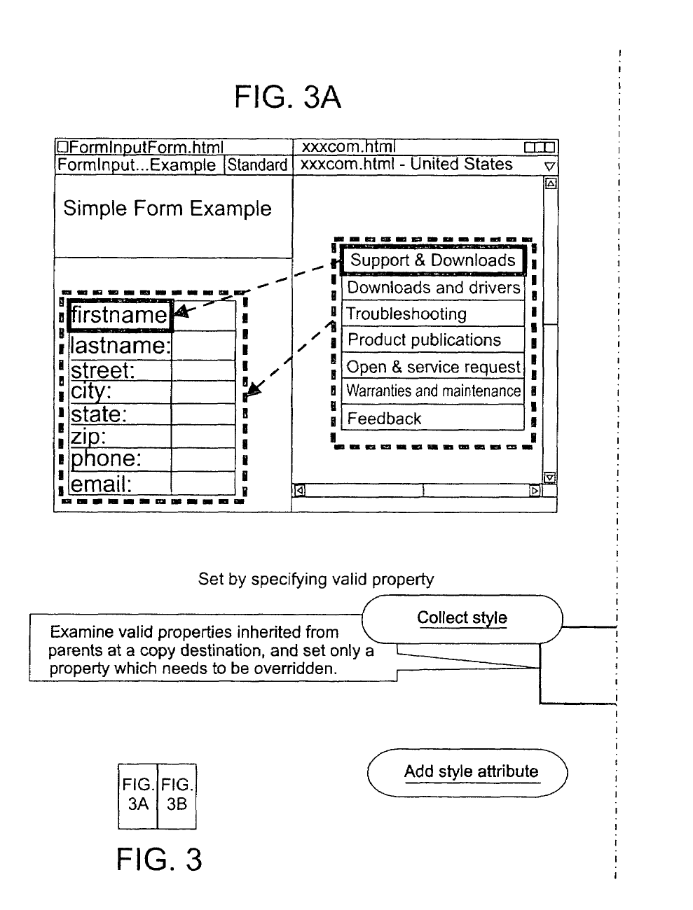

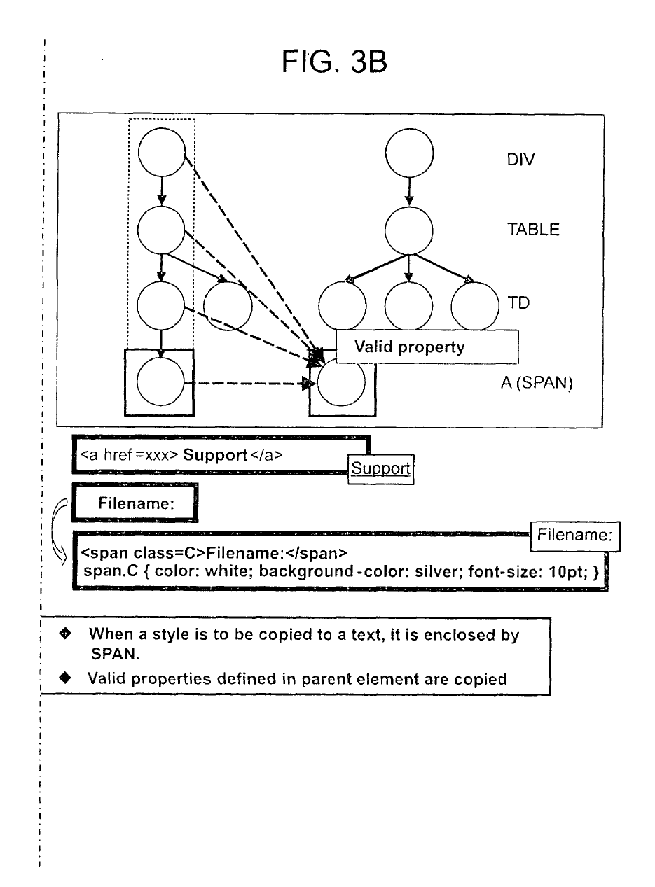

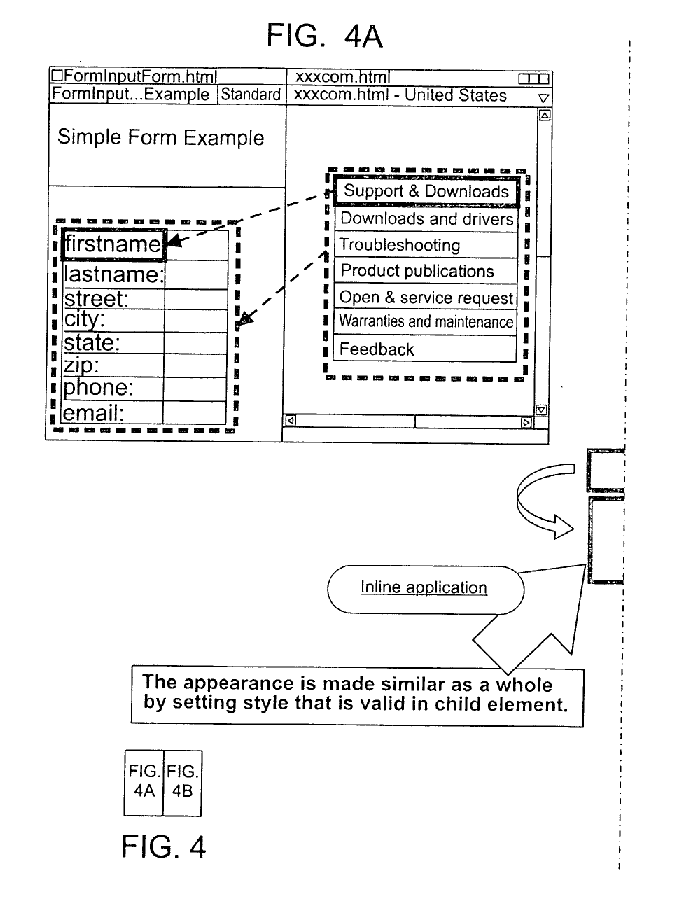

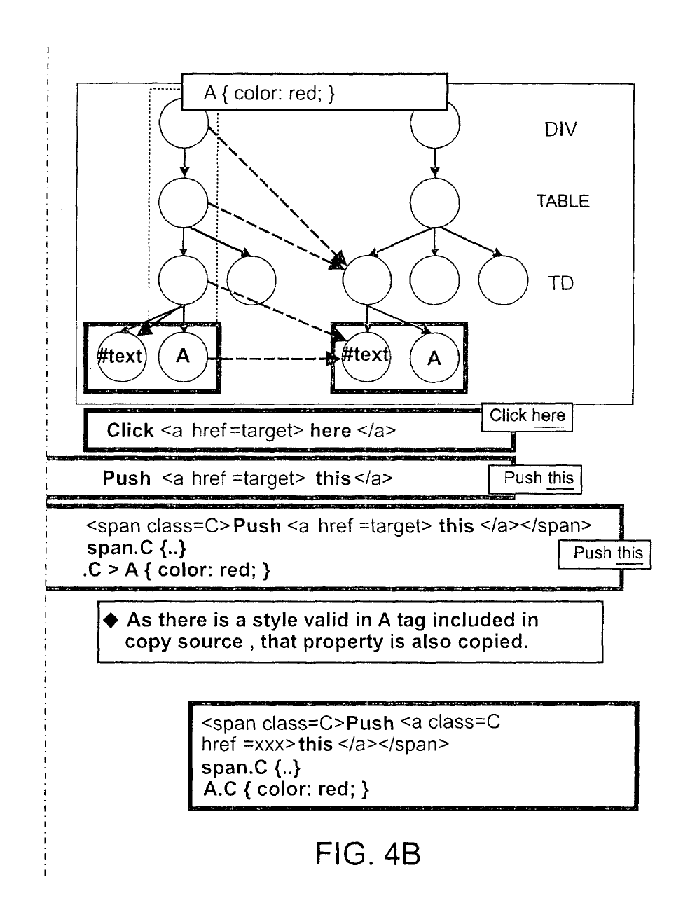

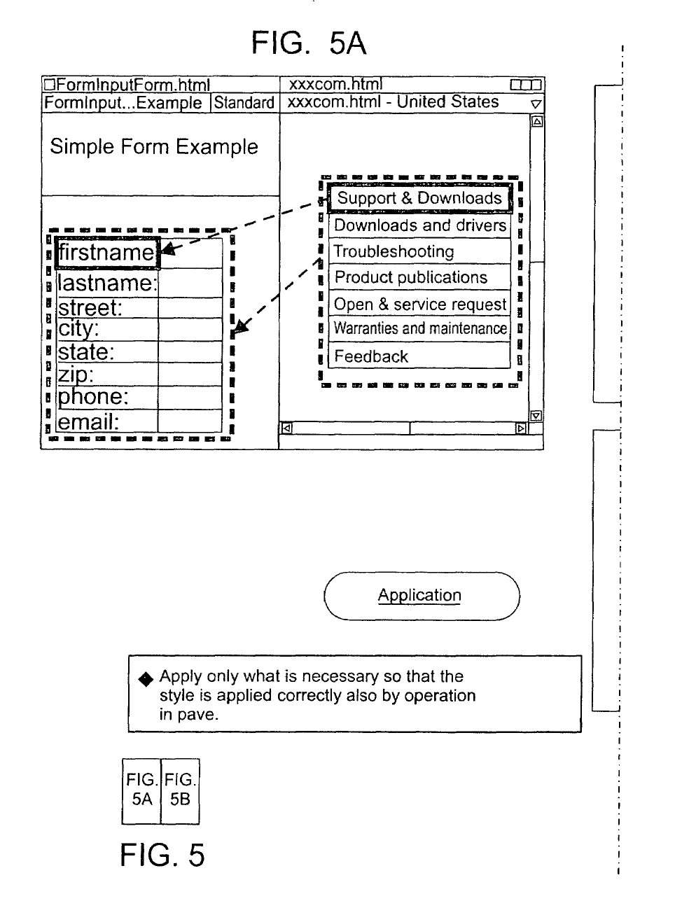

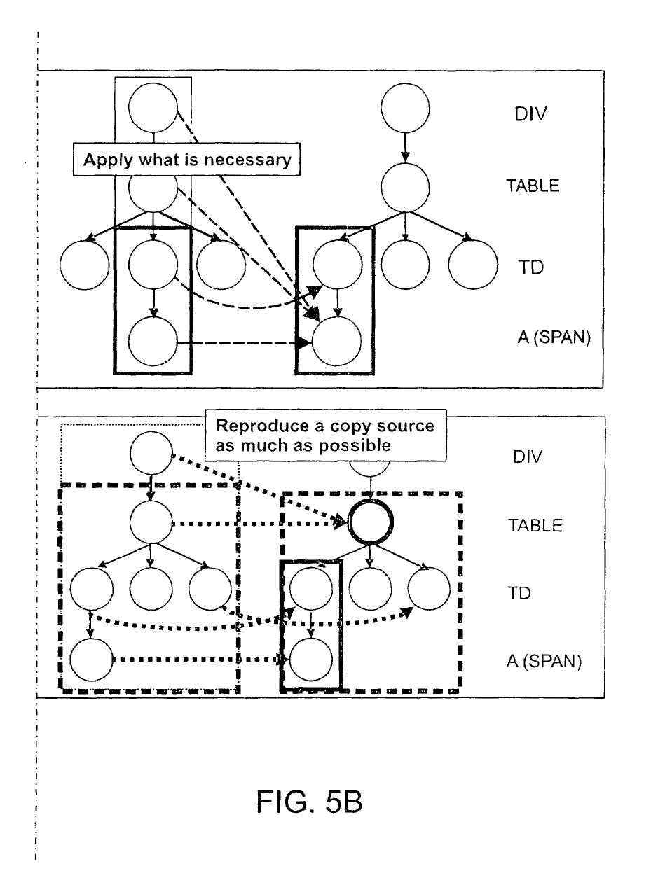

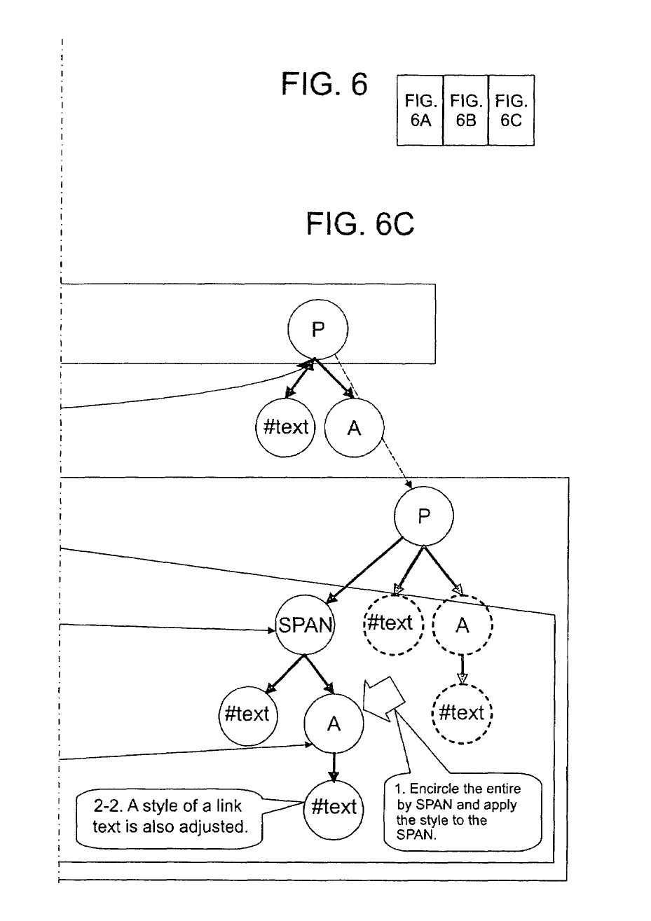

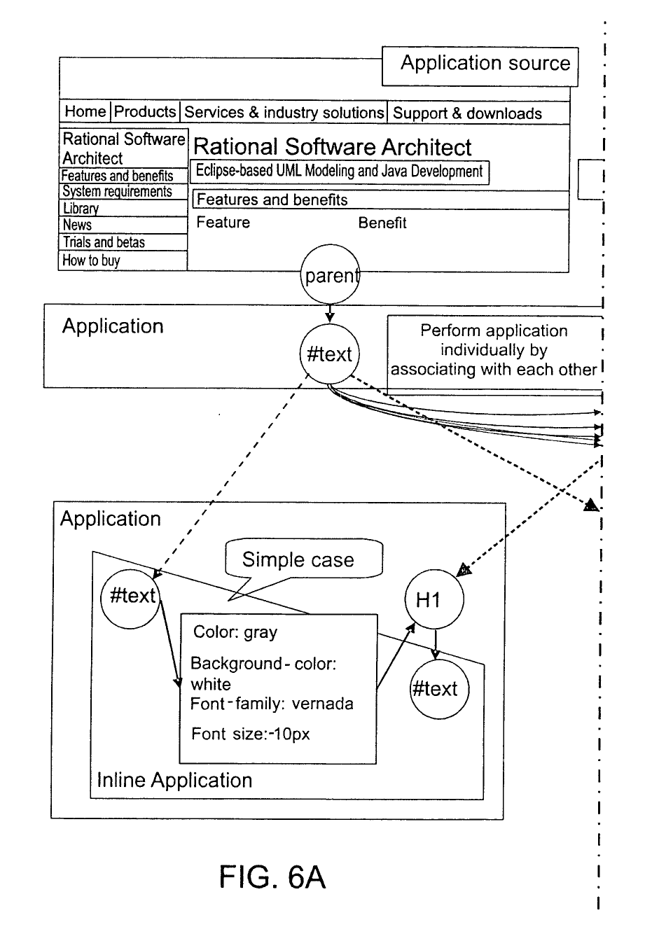

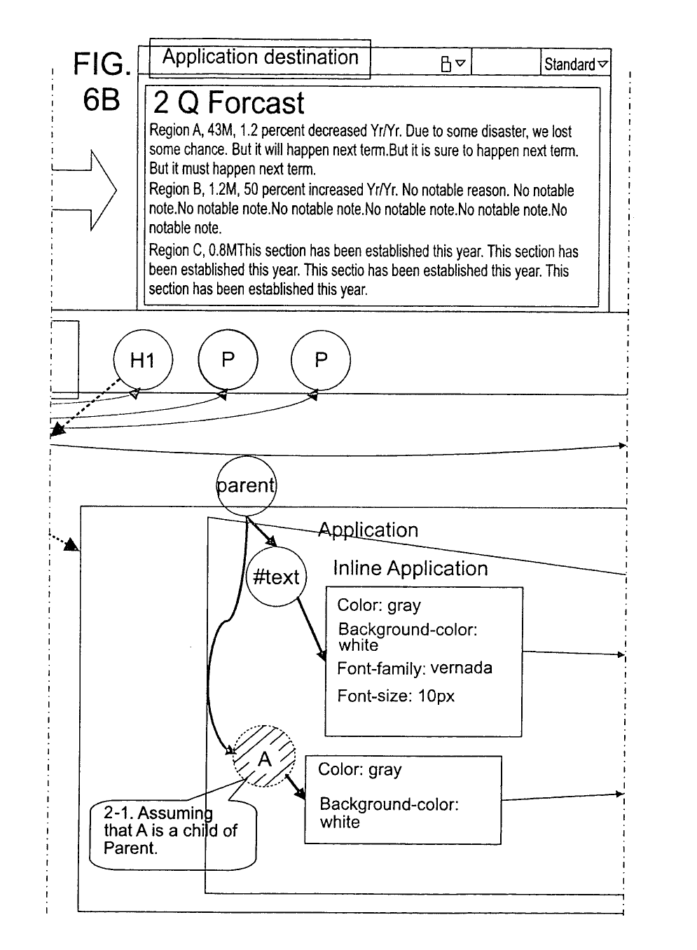

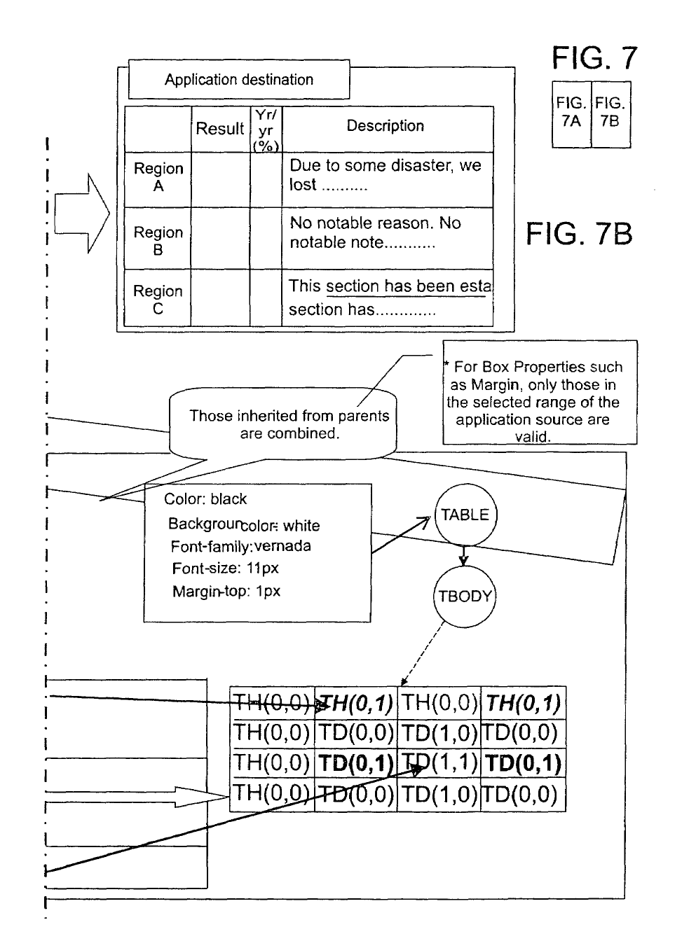

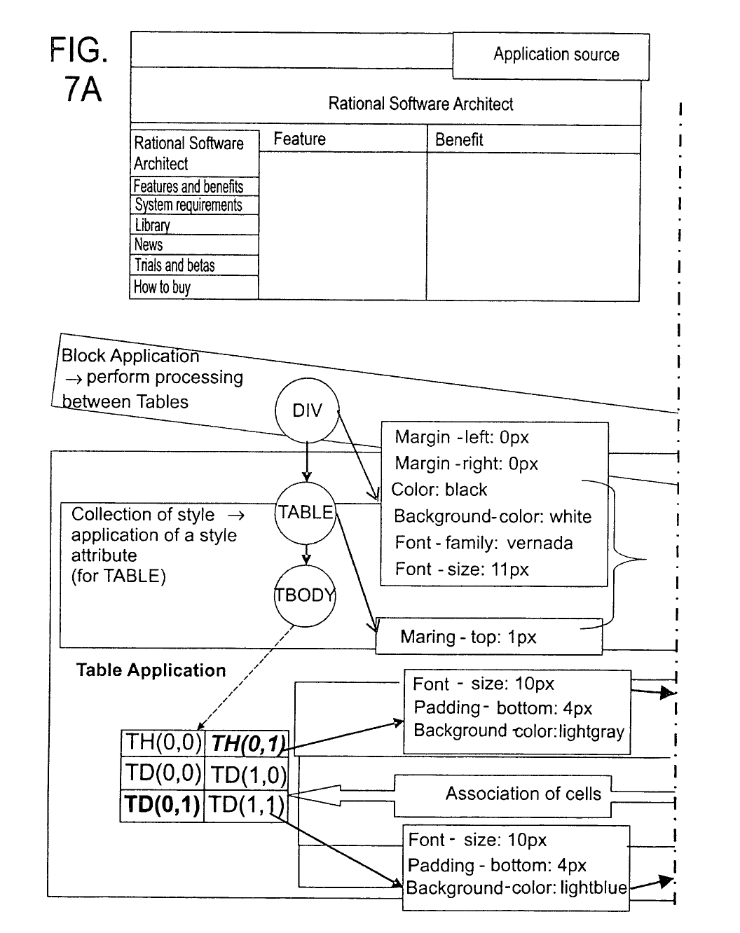

The following figures illustrate flow diagrams in accordance with exemplary embodiments. FIG. 3 illustrates a flow diagram illustrating the method of FIG. 2. FIG. 4 illustrates another flow diagram illustrating the method of FIG. 2. FIG. 5 illustrates a flow diagram for applying a style to an object in accordance with exemplary embodiments. FIG. 6 illustrates a flow diagram for text element mapping in accordance with exemplary embodiments. FIG. 7 illustrates a flow diagram of table mapping in accordance with exemplary embodiments.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. In a computer system having a display configured to display HTML documents, a method for applying styles from elements included in an existing HTML document, the method comprising:
applying an appearance of the existing HTML document by using CSS to HTML components in an HTML document being edited for each component, including:
setting an application source by selecting a range in the existing HTML document, wherein the range includes a DOM element, a DOM element string and a character string in a text node, and wherein the DOM element includes a child element selected from the group consisting of: a text with all space, a meaningless text, a comment, and a script;
setting an application destination in the HTML document being edited;
examining a CSS attribute that defines an appearance in each part in a component including attributes inherited from parents, including:
forming a new CSS for a document of a copy destination;
examining valid properties inherited from a parent page at the copy destination;
setting a property that is to be overridden;
setting a style that is valid in the child element;
copying a style that is valid in a tag included in a copy source; and
applying a defined CSS class to each part of the destination of the application including:
applying styles to objects to reproduce a copy source,
wherein components of the HTML document being edited for each component, which are not being edited remain unaffected;
wherein the valid properties inherited from a parent page at the copy destination are not included at the copy source,
wherein when elements of appearance at the copy source, an appearance of the copy destination can be changed.
